(19) United States
(12) Patent Application Publication
(10) Pub. No.: US 2026/0002651 A1
(43) Pub. Date: Jan. 1, 2026

(54) OPTICAL ELEMENT, LIGHTING UNIT, AND VEHICLE

(71) Applicant: Nordic Lights OY, Jakobstad (FI)

(72) Inventors: Yrjö MATIKAINEN, Jakobstad (FI); Olli SAARNIO, Jakobstad (FI)

(21) Appl. No.: 19/249,226

(22) Filed: Jun. 25, 2025

(30) Foreign Application Priority Data
Jun. 26, 2024 (EP) 24184576.7

(51) Int. Cl. F21S 41/32; F21S 41/20

(52) U.S. Cl. CPC F21S 41/322; F21S 41/285

(57) ABSTRACT

An optical element, a lighting unit and a vehicle are disclosed. The optical element comprises: one or more entry portions for receiving light rays from one or more light sources (120); one or more total internal reflection, TIR, surfaces (108) configured to receive light rays from the one or more entry portions and to focus, by TIR, the light rays received from the one or more entry portions in a vertical direction (y) and in a horizontal direction (x); and one or more exit portions (180) comprising one or more exit lenses (140), wherein the one or more exit lenses comprise a plurality of Fresnel structures configured to collimate and/or spread, in the horizontal direction and/or in the vertical direction, light rays exiting the optical element, wherein the optical element is formed as a monolithic body.

### CROSS-REFERENCE TO RELATED APPLICATIONS

The present application claims the benefit under 35 U.S.C. § 119(a) of European Patent Application No. 24184576.7, filed 26 Jun. 2024, the disclosure of which is incorporated herein by reference in its entirety.

### TECHNICAL FIELD

The present solution generally relates to an optical element for a vehicle headlamp, a lighting unit comprising the optical element, and a vehicle comprising the lighting unit.

### BACKGROUND

Vehicle headlamps are used to produce low beam and/or high beam light patterns to illuminate the area ahead of a vehicle. Headlamps are not limited for road traffic but are also used in working vehicles such as vehicles for construction, mining, agriculture, forestry, and material handling. Nevertheless, such headlamps may need to fulfil several requirements, including those set for vehicles in road traffic.

Headlamps aim to achieve precise and well-controlled lighting patterns while complying with various technical requirements. Headlamp users prefer good forward and lateral lighting performance with minimal glare for the user as well as oncoming traffic and passers-by. Size and manufacturing constraints are also considered, with an aim to reduce the size of headlamps while making them easy to manufacture. Thermal performance is another relevant consideration.

FR3010772A1 describes a light emitting device for a motor vehicle headlight and EP3653926B1 describes a lighting device for a motor vehicle headlamp and motor vehicle headlamp.

### SUMMARY

The scope of protection sought for various embodiments of the invention is set out by the independent claims. Various embodiments are disclosed in the dependent claims. The embodiments and features, if any, described in this specification that do not fall under the scope of the independent claims are to be interpreted as examples useful for understanding various embodiments of the invention.

According to a first aspect, an optical element for a vehicle headlamp comprises one or more entry portions for receiving light rays from one or more light sources; one or more total internal reflection, TIR, surfaces configured to receive light rays from the one or more entry portions and to focus, by TIR, the light rays received from the one or more entry portions in a vertical direction and in a horizontal direction; and one or more exit portions comprising one or more exit lenses, wherein the one or more exit lenses comprise a plurality of Fresnel structures configured to collimate and/or spread, in the horizontal direction and/or in the vertical direction, light rays exiting the optical element, wherein the optical element is formed as a monolithic body.

The optical element may comprise one or more light cutters configured to form, by TIR, a cutoff profile for light rays passing from the one or more entry portions to the one or more exit lenses.

The optical element may comprise one or more light collector surfaces configured to receive light rays reflected by the one or more light cutters, and to reflect, by TIR, the light rays received from the one or more light cutters towards the one or more exit lenses.

At least one of the one or more light collector surfaces may be configured to collimate the light rays received from the one or more light cutters towards the one or more exit lenses.

At least one of the one or more light collector surfaces may be configured to focus the light rays received from the one or more light cutters in the vertical direction and in the horizontal direction.

The optical element may comprise a plurality of light cutters and a plurality of exit portions, and first one or more light cutters of the plurality of light cutters may be arranged to form a cutoff profile for light rays received from the one or more entry portions and/or from the one or more TIR surfaces and configured to exit the optical element via first one or more exit portions of the plurality of exit portions, and second one or more light cutters of the plurality of light cutters may be arranged to form a cutoff profile for light rays received from the one or more light collector surfaces and configured to exit the optical element via second one or more exit portions of the plurality of exit portions.

The one or more TIR surfaces and/or the one or more light collector surfaces may comprise a plurality of flat and/or curved facets.

The plurality of Fresnel structures may comprise ring-shaped Fresnel structures, and/or horizontally and/or vertically stacked rectangular Fresnel structures.

The one or more exit portions may comprise one or more exit lenses devoid of Fresnel structures.

The plurality of Fresnel structures may comprise Fresnel structures of at least two different types.

The optical element may be made of, or comprise polycarbonate, polymethyl methacrylate, optical silicone, glass, or a mixture thereof.

At least one TIR surface of the one or more TIR surfaces may have a first focal point and a second focal point for focusing the light rays received from the one or more entry portions, wherein the first focal point and the second focal point are substantially coincident.

At least one TIR surface of the one or more TIR surfaces may have a first focal point and a second focal point for focusing the light rays received from the one or more entry portions, wherein the first focal point and the second focal point are noncoincident.

One of the first focal point and the second focal point may be positioned further from the at least one TIR surface than the other one of the first focal point and the second focal point.

The first focal point and the second focal point may be in different positions in the horizontal direction.

The one or more exit lenses may comprise a plurality of exit lenses comprising a plurality of the Fresnel structures.

The optical element may comprise a plurality of entry portions for receiving light rays from the one or more light sources, and a plurality of TIR surfaces configured to receive light rays from the plurality of entry portions and to focus, by TIR, the light rays received from the plurality of entry portions in the vertical direction and in the horizontal direction.

The plurality of TIR surfaces may comprise substantially parallel optical axes for focusing the light rays.

The plurality of TIR surfaces may comprise substantially nonparallel optical axes for focusing the light rays.

The one or more exit lenses may comprise a plurality of exit lenses including at least one exit lens for each of the plurality of TIR surfaces.

The optical element may comprise a plurality of horizontally and/or vertically adjacent exit lenses.

At least one of the one or more exit portions may comprise only one of the one or more exit lenses.

At least one focal point of one or more of the one or more TIR surfaces may be substantially coincident with a focal point of at least one of the one or more exit lenses.

At least one focal point of one or more of the one or more TIR surfaces may be substantially noncoincident with focal points of the one or more exit lenses.

The one or more exit lenses may comprise a first exit lens comprising first Fresnel structures configured to collimate a first part of the light rays exiting the optical element, and a second exit lens comprising second Fresnel structures configured to spread a second part of the light rays exiting the optical element.

The plurality of Fresnel structures of at least one of the one or more exit lenses may comprise first Fresnel structures configured to collimate light rays exiting the optical element and second Fresnel structures configured to spread light rays exiting the optical element.

The plurality of Fresnel structures of at least one of the one or more exit lenses may be configured to spread light rays exiting the optical element at two or more different spread angles.

According to a second aspect, a lighting unit comprises one or more light sources and one or more of the optical elements.

The lighting unit may be a vehicle headlamp.

According to a third aspect, a vehicle comprises the lighting unit.

### BRIEF DESCRIPTION

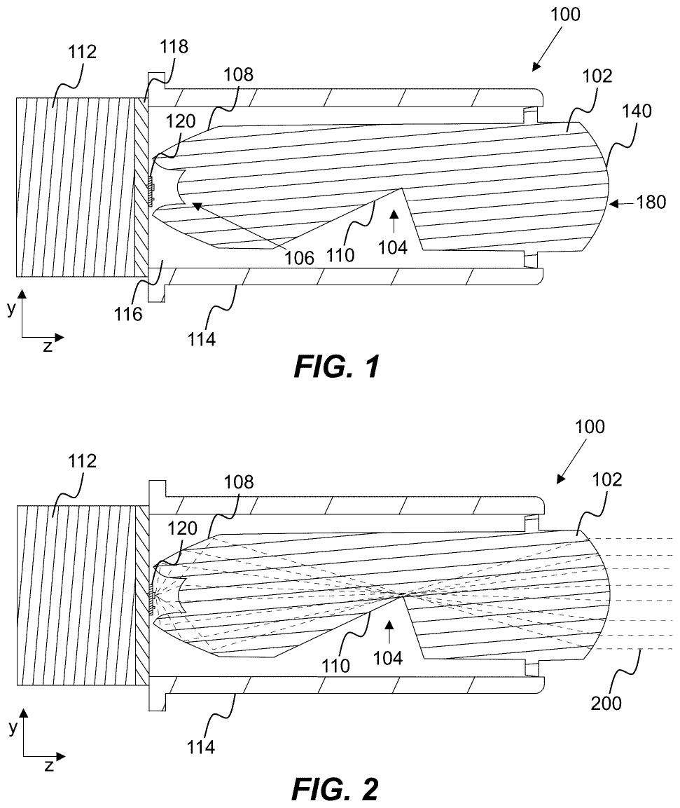

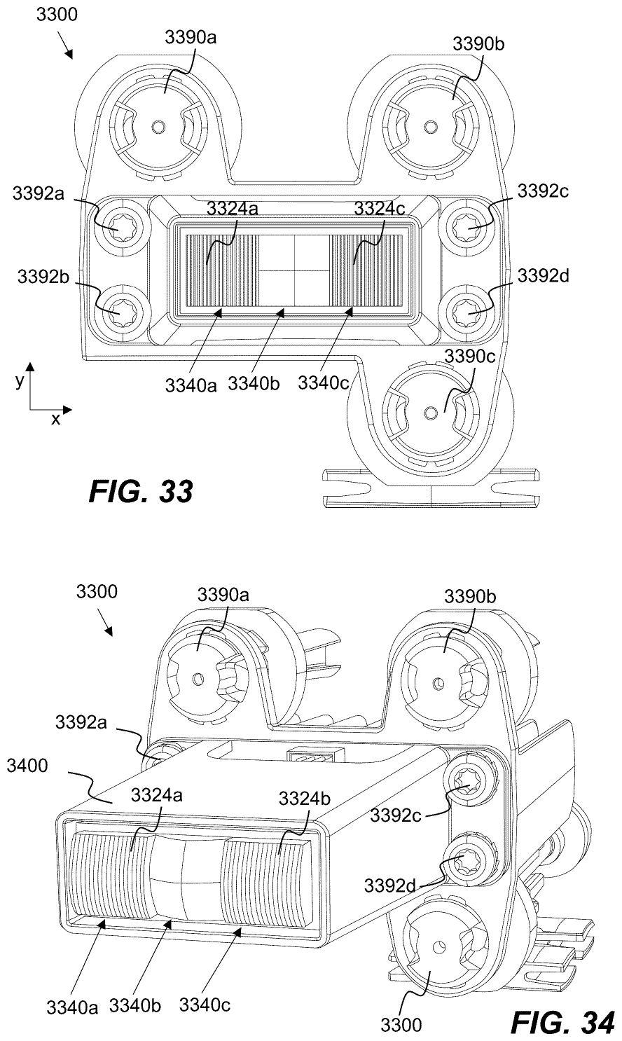

illustrates an embodiment of a headlamp;
illustrates the passage of light rays within the headlamp of FIG. 1;
shows a side view of embodiments of an optical element;
shows a bottom view of a first embodiment of the optical element;
shows a bottom view of a second embodiment of the optical element;
shows a top view of a third embodiment of the optical element;
shows a top view of a fourth embodiment of the optical element;
illustrates a low beam variant of the fourth embodiment;
illustrates a high beam variant of the fourth embodiment;
shows a bottom view of a fifth embodiment of the optical element;
illustrates the fifth embodiment;
illustrates a high beam variant of the fifth embodiment;
illustrates a sixth embodiment of the optical element;
illustrates a seventh embodiment of the optical element;
illustrates an eighth embodiment of the optical element;
illustrates a ninth embodiment of the optical element;
illustrates a tenth embodiment of the optical element;
illustrates an eleventh embodiment of the optical element;
shows a simulated light pattern for the tenth embodiment;
shows a simulated light pattern for the eleventh embodiment;
illustrates various configurations of focal points within the optical element;
illustrates further configurations of focal points within the optical element;
shows a side view of a twelfth embodiment of the optical element;
shows a top view of a thirteenth embodiment of the optical element;
shows a simulated light pattern for various embodiments of the optical element;
shows a simulated light pattern for various embodiments of the optical element with facets;
shows a side view of a fourteenth embodiment of the optical element;
illustrates a fifteenth embodiment of the optical element;
illustrates a sixteenth embodiment of the optical element;
shows a simulated light pattern for a total beam of the sixteenth embodiment;
shows a simulated light pattern for a lower beam of the sixteenth embodiment;
shows a simulated light pattern for an upper beam of the sixteenth
embodiment;
illustrates a headlamp with an optical element according to a seventeenth embodiment; and
shows a front view of the headlamp of FIG. 33.

### DETAILED DESCRIPTION

The following description and drawings are illustrative and are not to be construed as unnecessarily limiting. The specific details are provided for a thorough understanding of the disclosure. However, in certain instances, well-known or conventional details are not described in order to avoid obscuring the description. In this specification, reference to “one embodiment” or “an embodiment” means that a particular feature, structure, or characteristic described in connection with the embodiment is included in at least one embodiment of the disclosure. References to an embodiment can be, but are not necessarily, references to the same embodiment in the present disclosure.

The present disclosure relates to an optical element for a vehicle headlamp, a lighting unit comprising the optical element, and a vehicle comprising the lighting unit. While the optical element is suitable for use in a headlamp, it may also be used in other kinds of lighting units such as work lights. Work lights are often used to illuminate a working area where a worker, a working machine, and/or a working vehicle operates. The optical element is particularly suitable for various kinds of work lights as well as headlamps for working vehicles. The compact size and well-controlled light distribution characteristics of the optical element make it suitable for various working and driving scenarios.

Some examples of working vehicles include:
construction vehicles, such as articulated trucks, asphalt track pavers, wheel loader bulldozers/track dozers, compactors/road rollers, excavators, mobile cranes, motor graders/scrapers, pile drivers, skid steer loaders, and tele handlers
mining vehicles, such as articulated trucks, blast hole drills, bucket wheel excavators, borers/continuous miners, draglines, dump trucks, highwall miners, hydraulic/rope shovels, load haul dumps (LHD), rocket boomers/drilling jumbos, surface miners, and wheel loaders
forestry vehicles, such as chippers, delimbers, feller bunchers, forwarders, harvesters, knuckleboom loaders, logging trucks, skidders, swing machines, and track dozers
agricultural vehicles, such as bean harvesters, beet harvesters, combine harvesters, crop sprayers, forage harvesters, pea harvesters, potato harvesters, rape swathers, slurry spreaders, and tractors
material handling vehicles, such as fork lift trucks, rubber-tyre gantry cranes (RTG), reach stackers, straddle carriers, tow tractors, tele handlers, and truck mounted cranes.

Several directions are referred to herein to explain various aspects of the embodiments and their features, as is customary in the technical field. The horizontal direction refers to a direction extending side to side or left to right when viewing the light emitting surface of the headlamp or the optical element from ahead. This viewpoint corresponds nearly to that of oncoming traffic when the headlamp is mounted on a vehicle. The vertical direction refers to a direction extending upwards and downwards when viewing the light emitting surface of the headlamp or the optical element from ahead. The longitudinal direction refers to a direction extending into and out of the headlamp and/or the optical element when viewing the light emitting surface of the headlamp or the optical element from ahead. The longitudinal direction may extend along a longitudinal axis of the optical element, as shown in the figures. The horizontal direction is denoted by x, the vertical direction is denoted by y, and the longitudinal direction is denoted by z herein and in the drawings. Axes showing the relevant directions are provided in some of the drawings to facilitate understanding of the different embodiments and their features.

FIG. 1 illustrates a vehicle headlamp 100 according to an embodiment. The headlamp comprises a light source 120, preferably a light emitting diode (LED) light source, in a space 116 facing an entry portion 106 of an optical element 102. The optical element of the embodiment comprises a light cutter 104 for forming a cutoff profile for light rays emitted by the light source. The light cutter is formed as a dent or cavity within the optical element such that the light cutter blocks or redirects light rays travelling towards the light cutter from the light source, thus forming a cutoff profile for light rays that exit the optical element via its exit lens 140. The cutoff profile makes the optical element suitable for use in a low beam headlamp, and thus the headlamp 100 may be a low beam headlamp. Alternatively, the optical element may be implemented without the light cutter 104 such that no cutoff profile is formed. Such an optical element is suitable for use in a high beam headlamp. All of the embodiments discussed herein may be implemented with or without light cutter(s), unless otherwise indicated. Optical elements with partial light cutters affecting only some of the light rays, and combinations of two or more optical elements—at least one with a light cutter and at least one without—are also contemplated to achieve a combined high beam and low beam headlight. Some details of the light cutters illustrated in the drawings and described herein have been omitted to avoid obscuring the description.

Suitable light sources for the headlamp include LEDs such as automotive LEDs, which are generally smaller and more powerful than other types of LEDs. Other suitable light sources include LEP (Laser Excited Phosphor) light sources, which allow for an even smaller size. LEPs have a smaller LES (Light Emitting Spot) than to LEDs. The light source 120 may comprise one or more light sources, such as those mentioned above.

The headlamp 100 further comprises a heat sink 112 and a holder 114 for the optical element 102. In the embodiment shown the optical element 102 is surrounded by empty space 116 (filled with e.g. air) within the holder 114. A printed circuit board (PCB) 118 is located between the heat sink and the holder. The light source 120 is mounted and electrically coupled to the PCB. Light emitted by the light source may be controlled by the PCB.

The optical element 102 is preferably formed as a single piece or a monolithic body. The optical element is made of material that is transparent or transmissive (to light), preferably a single material or a substantially homogeneous mixture of materials. For example, the optical element may comprise, or be made of: polycarbonate (PC), polymethyl methacrylate (PMMA), optical silicone such as polydimethysiloxane (PDMS), glass, or a mixture comprising one or more of the aforementioned materials. Optical silicone may also be known as mouldable silicone. The surface of the optical element facilitates total internal reflection (TIR) for light rays travelling within the optical element when they meet the surface of the optical element at certain angles. The skilled person is aware of the principles of TIR.

The optical element may be manufactured by e.g. injection molding or liquid silicone rubber (LSR) injection molding. These techniques apply especially to optical elements comprising or made of PMMA, PC and/or PDMS, and allow for good tolerances. Another suitable technique is precision glass moulding, especially for optical elements comprising or made of glass.

The optical element may be partially or entirely coated with one or more materials and/or layers of materials (e.g. metallization) that provides or enhances its TIR properties or other optical properties, as well as increases efficiency. Such coating(s) may be applied e.g. by vacuum metallization. The optical element may be partially enclosed, at least at the TIR surface and optionally at other parts, by a material that provides or enhances its TIR properties. For example, the space around the optical element in the headlamp of FIG. 1 may be filled with such a material.

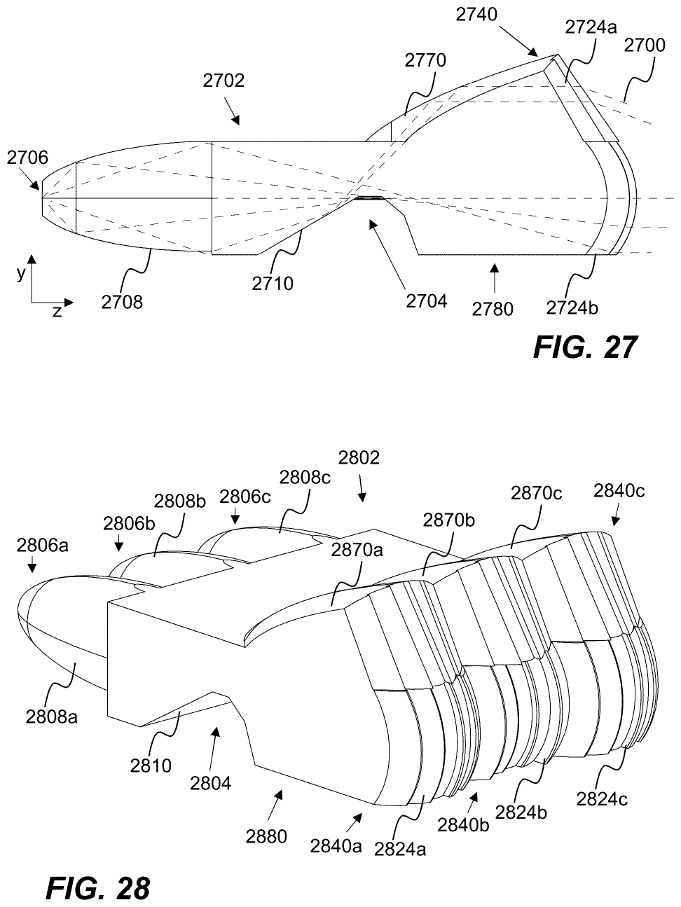

If the TIR surface 110 of the light cutter is coated with metallization, a cleaner light cutting effect can be achieved. Considering the embodiments FIGS. 27 to 29, the extra light that is reflected upwards can improve efficiency of light output.

The TIR surface 108 may alternatively or additionally be coated with metallization. This can improve the TIR effect, especially for light rays arriving at too high of an angle of incidence. This further improves efficiency.

Surfaces of the entry portion 106 through which light enters the optical element and/or those of the exit lens 140 may be coated by one or more anti-reflective (AR) coatings. AR coatings applied e.g. as thin layers of materials with specific refractive indices minimize the amount of reflective light by creating destructive interference for reflected light waves. This interference cancels out the reflections, allowing more light to pass through the surface, and reduces glare.

As mentioned above, the surface of the optical element is configured to perform TIR for light rays travelling within the optical element. The surface performs TIR for light rays traveling from the light source 120 towards an exit portion 180 with the exit lens 140 of the optical element in an opposite end of the optical element where light rays exit the optical element. A TIR surface 108 is formed near the entry portion of the optical element for reflecting light rays received via the entry portion towards the exit portion of the optical element. The light cutter also comprises a TIR surface 110 that reflects light arriving from the TIR surface 108 or directly from the light source 120 via the entry portion of the optical element. More detailed explanations on the operation of the TIR surface 108, the light cutter 104, and the exit lens 140 are provided below in relation to this embodiment and further embodiments.

FIG. 2 depicts the passage of light rays 200 emitted by the light source 120 in the optical element 102 of the headlamp 100 of FIG. 1. Light emitted by the light source enters the optical element via the entry portion 106 (see FIG. 1). In the embodiment, the entry portion comprises a plurality of entry surfaces configured to refract the light rays emitted by the light source as they enter the optical element 102. As shown in FIG. 2, the entry surfaces are configured to focus the light rays (by refraction). Alternatively or additionally, the entry portion may be configured to spread (by refraction) and/or merely transmit the light rays.

A first portion of the light rays travels from the entry portion towards the TIR surface 108 of the optical element and a second portion of the focused light rays travels from the entry portion towards the exit portion of the optical element. The first portion of the light rays is reflected and focused by the TIR surface by TIR. The TIR surface has one or more focal points for focusing the light rays in a vertical direction y and in a horizontal direction which extends into the figure perpendicularly to directions y and z. For example, the TIR surface may have a first focal point for focusing the light rays in the vertical direction y, and a second focal point for focusing the light rays in the horizontal direction. This may be implemented e.g. with an elliptically shaped TIR surface.

The TIR surface may have full rotational symmetry or circular symmetry around an (optical) axis. In this case, the above-mentioned first and second focal points are coincident. The (optical) axis is preferably parallel to the direction z shown in FIGS. 1 and 2. The (optical) axis thus extends lengthwise along the headlamp 100 and the optical element 102 from the light source 120 to the exit lens 140.

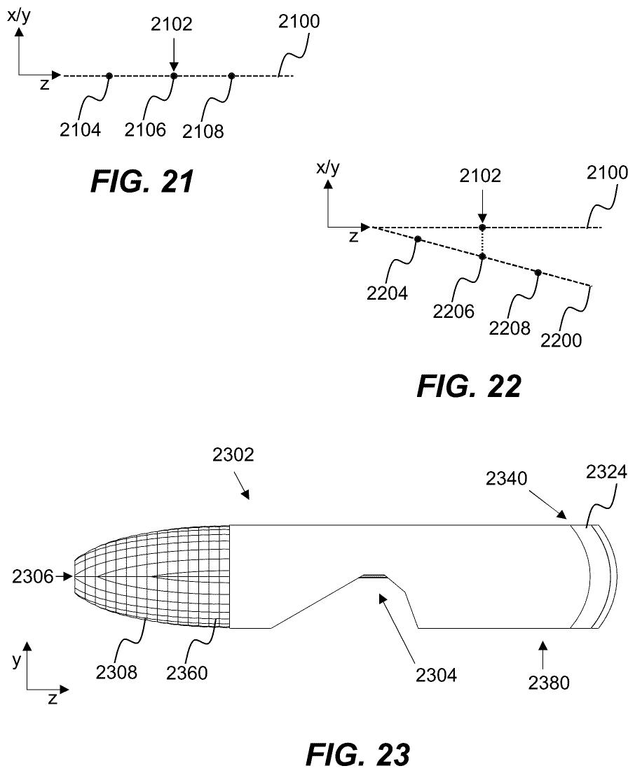

The focal point(s) of the TIR surface are preferably coincident with the light cutter 104. For example, the focal point(s) may be coincident with a tip of the light cutter. FIG. 2 shows the first focal point of the TIR surface 108 for focusing the light rays in the vertical direction y being coincident with a tip of the light cutter. Coincidence with the light cutter (most preferably its tip) is preferred for automotive headlights due to their specific requirements for the properties of the cut-off light pattern produced using the light cutter, as a sharper cutoff may be achieved. However, spreading of the light rays may be controlled better if one or more of the focal points of the TIR surface 108 are offset or shifted away from the (tip of) the light cutter 104. A further benefit is widening of a thermal peak caused by arriving light rays, and thus reducing thermal load at the light cutter 104. Preferably, a focal point of the TIR surface for focusing the light rays in the horizontal direction is offset from the (tip of) the light cutter, and preferably a focal point of the TIR surface for focusing the light rays in the vertical y direction is coincident with a (tip of) the light cutter. This achieves a precise cut-off in the light pattern produced by a headlamp with the optical element while reducing thermal load caused by the light rays arriving at the light cutter. Various configurations of focal points within the optical element are discussed in more detail later with reference to FIGS. 21 and 22.

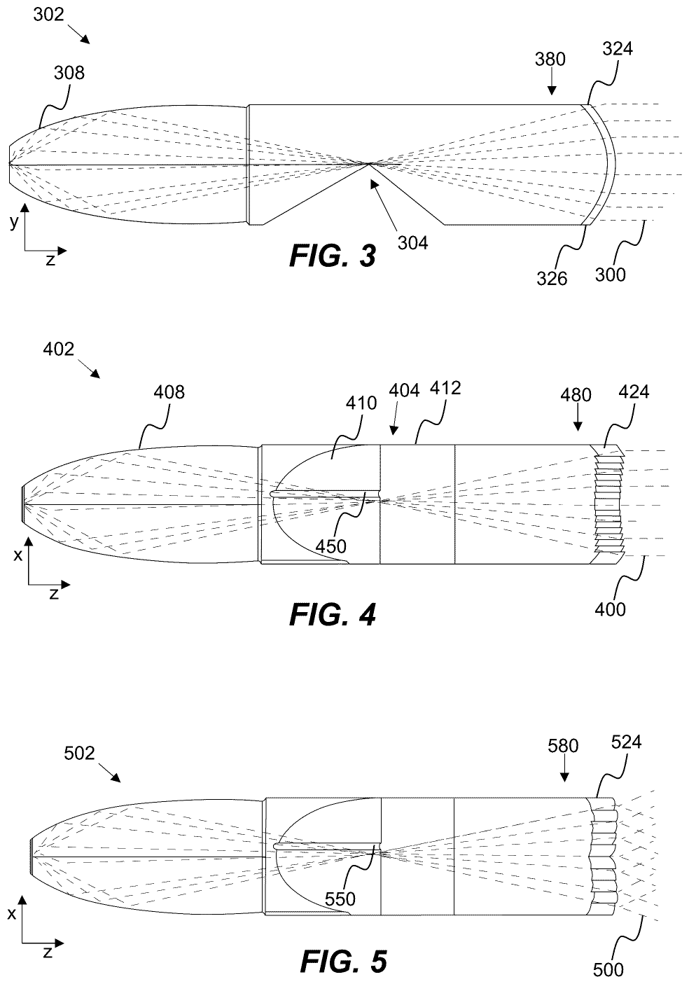

FIG. 3 shows a side view of several embodiments of the optical element 302. Light rays 300 travel from an entry portion to a TIR surface 308. The TIR surface focuses light rays in the vertical direction y. The TIR surface has a focal point for focusing the light rays in the vertical y direction. The focal point is substantially coincident with the tip of the light cutter 304. The light rays travel to an exit portion 380, wherein one or more exit lenses with Fresnel structures 324, 326 collimate the light rays in the vertical direction y. The one or more exit lenses may additionally collimate and/or spread the light rays in the horizontal direction which extends into the figure perpendicularly to directions y and z. The optical element 302 may be otherwise similar to that shown in FIGS. 1 and 2.

FIG. 4 shows a bottom view of a first embodiment of the optical element 402. Light rays 400 travel from an entry portion to a TIR surface 408. The TIR surface focuses light rays in the horizontal direction x. The TIR surface has a focal point for focusing the light rays in the horizontal direction. The focal point is substantially coincident with the tip of the light cutter 404, i.e. the joint between surfaces 410 and 412 which form the cavity acting as the light cutter. The light cutter comprises a longitudinal groove 450 for blocking light in a specific area of the light pattern. Herein, the specific area is on the side of oncoming traffic and the groove improves the low beam light pattern. The light rays travel to an exit portion 480, wherein an exit lens with a plurality of Fresnel structures 424 collimates the light rays in the horizontal direction x. The optical element 402 may otherwise be similar to those shown in FIG. 1-3.

FIG. 5 shows a top view of a second embodiment of the optical element 502. The second embodiment is otherwise similar to the first embodiment, but the exit portion 580 of the optical element comprises an exit lens with a plurality of Fresnel structures 524 which are configured to spread the light rays 500 in the horizontal direction x.

The Fresnel structures 524 may be configured to spread the light rays at different (nonzero) spread angles, i.e. some light rays are spread more than others. Different spread angles may be achieved by different Fresnel structures; for example, a first Fresnel structure may be configured to spread the light rays at a first spread angle, and a second Fresnel structure may be configured to spread the light rays at a second spread angle that is different from the first spread angle. The spread angle may be measured with respect to an optical axis parallel to the longitudinal direction z. For completeness, collimated light rays may have a spread angle equal to zero, and spread light rays may have a nonzero spread angle. This applies to all embodiments wherein spreading Fresnel structures are present. Different spread angles allow generating very finely tuned light patterns.

The first and second embodiments may be combined such that an exit lens comprises both Fresnel structures configured to collimate the light rays and Fresnel structures configured to spread the light rays. In this case the Fresnel structures are part of the same exit lens. A compact and multifunctional design is thus achieved. A plurality of such lenses may be included in the optical element,

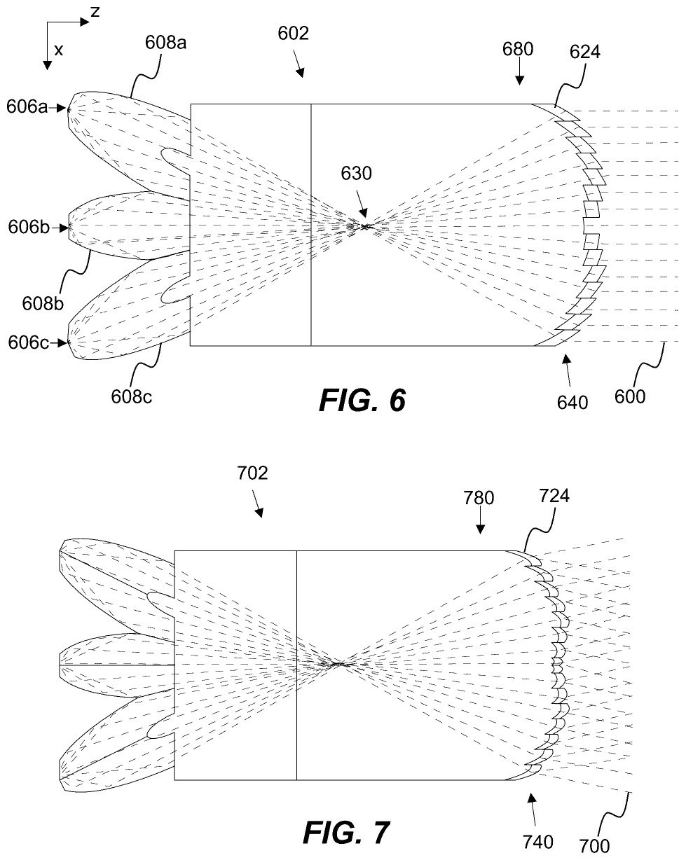

FIG. 6 shows a top view of a third embodiment of the optical element 602. The optical element 602 comprises a plurality of entry portions 606a-c with corresponding plurality of TIR surfaces 608a-c. A light source may be provided at each one of the entry portions 606a-c. Each of the plurality of TIR surfaces may be similar to those discussed above in relation to FIG. 1-3. A first entry portion 606a has a corresponding first TIR surface 608a for focusing light rays received from the first entry portion 606a, a second entry portion 606b has a corresponding second TIR surface 608b for focusing light rays received from the second entry portion 606b, and a third entry portion 606b has a corresponding third TIR surface 608c for focusing light rays received from the third entry portion 606b. The plurality of TIR surfaces, i.e. the first TIR surface 608a, the second TIR surface 608b, and the third TIR surface 608c, focus the light rays received from the plurality of entry portions, i.e. the first entry portion 606a, the second entry portion 606b, and the third entry portion 606c. Focusing the light rays in the horizontal direction x is shown in FIG. 6; the TIR surfaces may also perform focusing in the vertical direction as shown in FIG. 3.

In the third embodiment the plurality of TIR surfaces comprise substantially nonparallel optical axes for focusing the light rays 600. This applies for focusing the light rays in the horizontal direction x as shown in FIG. 6; when the TIR surfaces also perform focusing in the vertical direction as shown in FIG. 3, they may have substantially parallel or substantially nonparallel optical axes for focusing the light rays in the vertical direction.

The TIR surfaces 608a-c each have a focal point for focusing the light rays in the horizontal direction x. These focal points of the TIR surfaces are substantially coincident and thus form a common focal point 630. The common focal point is substantially coincident with a focal point of an exit lens 640 of the exit portion 680 of the optical element. A single exit lens 640 shared by a plurality of light sources and their corresponding entry portions 606a-c and TIR surfaces 608a-c is optically more efficient as it reduces losses of light in between or at the edges of a plurality of exit lenses. Coincidence of the focal point(s) of the TIR surface(s) 608a-c and the focal point of the exit lens 640 provides for a larger spike in intensity in the resulting lighting pattern of the optical element 602. The single exit lens 640 comprises a plurality of Fresnel structures 624 which are configured to collimate the light rays 600 in the horizontal direction x. The collimation is enhanced by the coincidence of the focal points of the TIR surfaces 608a-c and the exit lens 640.

FIG. 7 shows a top view of a fourth embodiment of the optical element 702. The fourth embodiment is otherwise similar to the third embodiment, but the exit portion 780 of the optical element comprises an exit lens 740 with a plurality of Fresnel structures 724 which are configured to spread the light rays in the horizontal direction X.

The third and fourth embodiments may be combined such that an exit lens comprises both Fresnel structures configured to collimate the light rays 700 and Fresnel structures configured to spread the light rays 700.

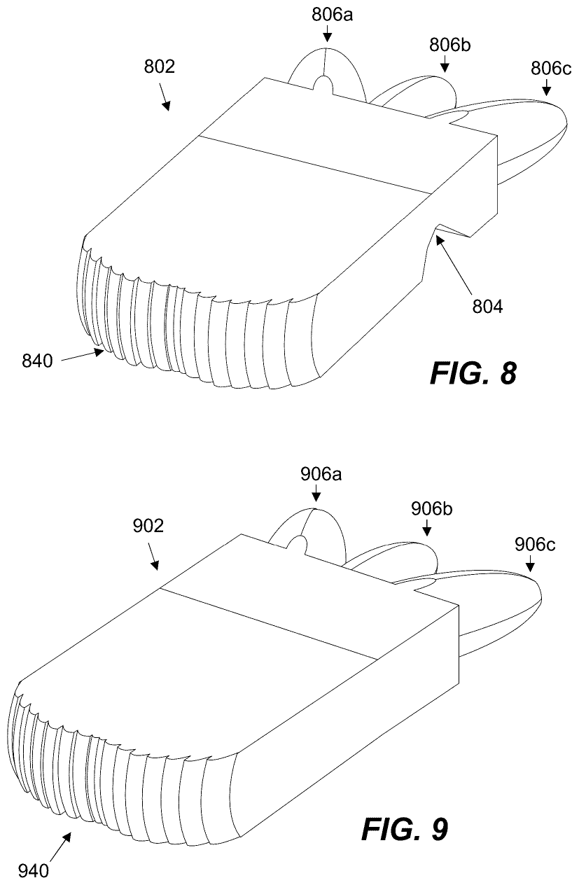

FIG. 8 illustrates a low beam variant of the fourth embodiment. The optical element 802 shown in FIG. 8 has a light cutter for forming cutoff profile for light rays passing from the entry portions 806a-c to the exit lens 840. The light cutter is similar to those discussed in relation to the preceding figures. The optical element 802 otherwise has the features discussed in relation to the fourth embodiment.

FIG. 9 illustrates a high beam variant of the fourth embodiment. The optical element 902 lacks a light cutter and thus no sharp cutoff profile is formed for light rays passing from the entry portions 906a-c to the exit lens 940. The optical element 902 otherwise has the features discussed in relation to the fourth embodiment.

The third embodiment of FIG. 6 may be implemented as a low beam variant, i.e. with a light cutter, and as a high beam variant, i.e. without a light cutter, as well.

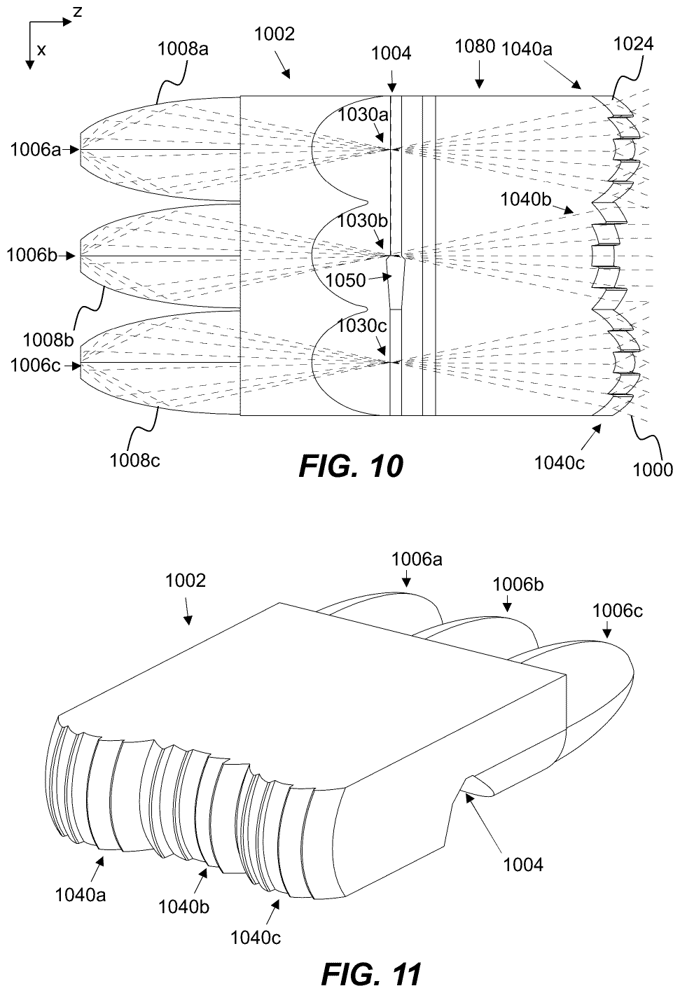

FIG. 10 shows a bottom view of a fifth embodiment of the optical element 1002. Similarly to the third and fourth embodiments, the optical element 1002 comprises a plurality of entry portions 1006a-c with corresponding plurality of TIR surfaces 1008a-c. A light source may be provided at each one of the entry portions 1006a-c. Each of the plurality of TIR surfaces may be similar to those discussed above in relation to FIG. 1-3. A first entry portion 1006a has a corresponding first TIR surface 1008a for focusing light rays received from the first entry portion 1006a, a second entry portion 1006b has a corresponding second TIR surface 1008b for focusing light rays received from the second entry portion 1006b, and a third entry portion 1006b has a corresponding third TIR surface 1008c for focusing light rays received from the third entry portion 1006b. The plurality of TIR surfaces, i.e. the first TIR surface 1008a, the second TIR surface 1008b, and the third TIR surface 608c, focus the light rays received from the plurality of entry portions, i.e. the first entry portion 1006a, the second entry portion 1006b, and the third entry portion 1006c. Focusing the light rays in the horizontal direction x is shown in FIG. 10; the TIR surfaces may also perform focusing in the vertical direction as shown in FIG. 3.

In the fifth embodiment the plurality of TIR surfaces comprise substantially parallel optical axes for focusing the light rays 1000. This applies for focusing the light rays in the horizontal direction x as shown in FIG. 10; when the TIR surfaces also perform focusing in the vertical direction as shown in FIG. 3, they may have substantially parallel or substantially nonparallel optical axes for focusing the light rays in the vertical direction.

The TIR surfaces 1008a-c each have a focal point 1030a-c for focusing the light rays in the horizontal direction x. These focal points of the TIR surfaces are noncoincident. These focal points are substantially coincident with corresponding focal points of exit lenses 1040a-c of the exit portion of the optical element. Technical effects of this coincidence have been discussed above in relation to FIG. 6.

As mentioned above, the optical element 1002 comprises an exit portion 1080 with a plurality of exit lenses 1040a-c, one for each of the TIR surfaces 1008a-c. These exit lenses are adjacent in the horizontal direction x. A first exit lens 1040a is configured to receive light rays reflected by the first TIR surface 1008a, a second exit lens 1040b is configured to receive light rays reflected by the second TIR surface 1008b, and a third exit lens 1040c is configured to receive light rays reflected by the third TIR surface 1008c. This matching provides for precise control of the light pattern generated by the optical element for each light source and its corresponding entry portion 1006a-c and TIR surface 1008a-c. Alternatively or additionally, a plurality of exit lenses may be provided for a single light source, corresponding entry portion and/or TIR surface while maintaining the aforementioned technical effect.

The first and third exit lenses 1040a, 1040c are configured to spread the part of the light rays 1000 that exit the optical element through the first or third exit lens. The second exit lens is configured to collimate the part of the light rays 1000 that exit the optical element through the second exit lens. As discussed above, light rays traveling from the first entry portion 1006a will generally arrive to the first exit lens 1040a, some of them being reflected by the first TIR surface 1008a. Light rays traveling from the second entry portion 1006b will generally arrive to the second exit lens 1040b, some of them being reflected by the second TIR surface 1008b. Light rays traveling from the third entry portion 1006c will generally arrive to the third exit lens 1040c, some of them being reflected by the third TIR surface 1008c. Thus, a part of the light rays exiting the optical element are subjected to spreading exit lenses 1040a, 1040c, and a part of the light rays are subjected to a collimating exit lens 1040b. There may be one or more of each type (spreading or collimating) of exit lens, and their exact number and arrangement may be selected based on the desired light pattern. The arrangement shown in FIG. 10, with spreading exit lenses at the edges and collimating between them, provides a light pattern relatively similar to that shown in FIG. 19.

The collimating and spreading functions of the exit lenses 1040a-c are provided by their Fresnel structures 1024. Each of the exit lenses 1040a-c comprises a plurality of the Fresnel structures. The first exit lens 1040a comprises a plurality of Fresnel structures 1024 configured to spread the light rays exiting the optical element via the first exit lens. The second exit lens 1040b comprises a plurality of Fresnel structures configured to collimate the light rays exiting the optical element via the second exit lens. The third exit lens 1040c comprises a plurality of Fresnel structures configured to spread the light rays exiting the optical element via the third exit lens. FIG. 10 shows the collimating and the spreading in the horizontal direction x; the exit lenses may additionally collimate and/or spread the light rays in the vertical direction which extends into the figure perpendicularly to directions x and z.

A light cutter 1004 is also shown in FIG. 10. The focal points 1030a-c of the TIR surfaces 1008a-c coincide with a tip of the light cutter 1004, providing a sharp cutoff in the light pattern. The light cutter 1004 includes a transition portion 1050 for creating an asymmetric light pattern along the x direction, which is particularly suitable headlamps for left-traffic or right-traffic.

FIG. 11 illustrates the fifth embodiment from another angle, further showing the shape of the light cutter 1004. The light cutter 804 of FIG. 8 and the light cutter 1004 of FIG. 10 have similar shapes, but other shapes, such as that shown in FIG. 3, are also suitable. The skilled person is able to design the shape of the light cutter of any of the embodiments in accordance with desired light pattern requirements.

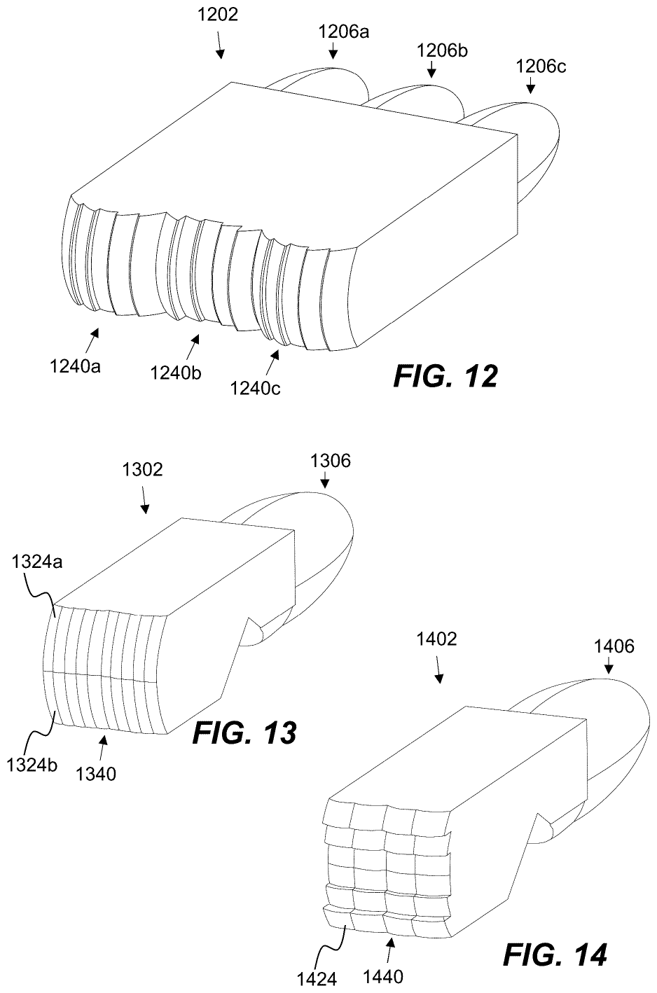

FIG. 12 illustrates a high beam variant of the fifth embodiment. The optical element 1202 lacks a light cutter and thus no sharp cutoff profile is formed for light rays passing from the entry portions 1206a-c to the exit lenses 1240a-c. The optical element 1202 otherwise has the features discussed in relation to the fifth embodiment.

Different types of Fresnel structures are now discussed with reference to sixth, seventh, eighth, ninth and tenth embodiments of the optical element. The Fresnel structures illustrated and described in relation to these embodiments are compatible with all other embodiments of the optical element as well. The Fresnel structures provide for a high degree of freedom for designing optics for different arrangements.

FIG. 13 illustrates a sixth embodiment of the optical element 1302. The optical element comprises an entry portion 1306 and an exit lens 1340. The exit lens comprises a plurality of horizontally and vertically stacked vertical Fresnel structures 1324a, 1324b. The vertical Fresnel structures are rectangular in shape when viewed from ahead. Upper Fresnel structures 1324a are horizontally stacked or adjacent with respect to each other, and lower Fresnel structures 1324b are horizontally stacked or adjacent with respect to each other. The upper Fresnel structures 1324a are vertically stacked or adjacent with respect to the lower Fresnel structures 1324b. The optical element 1302 may otherwise be similar to that shown in FIG. 3.

FIG. 14 illustrates a seventh embodiment of the optical element 1402. The optical element comprises an entry portion 1406 and an exit lens 1440. The exit lens comprises a plurality of horizontally and vertically stacked Fresnel structures 1424. The Fresnel structures are rectangular, or optionally square, in shape when viewed from ahead. The optical element 1402 may otherwise be similar to those shown in FIGS. 3 and 13.

Rectangular or square Fresnel structures aid with producing light patterns of similar (i.e. rectangular or square) shapes.

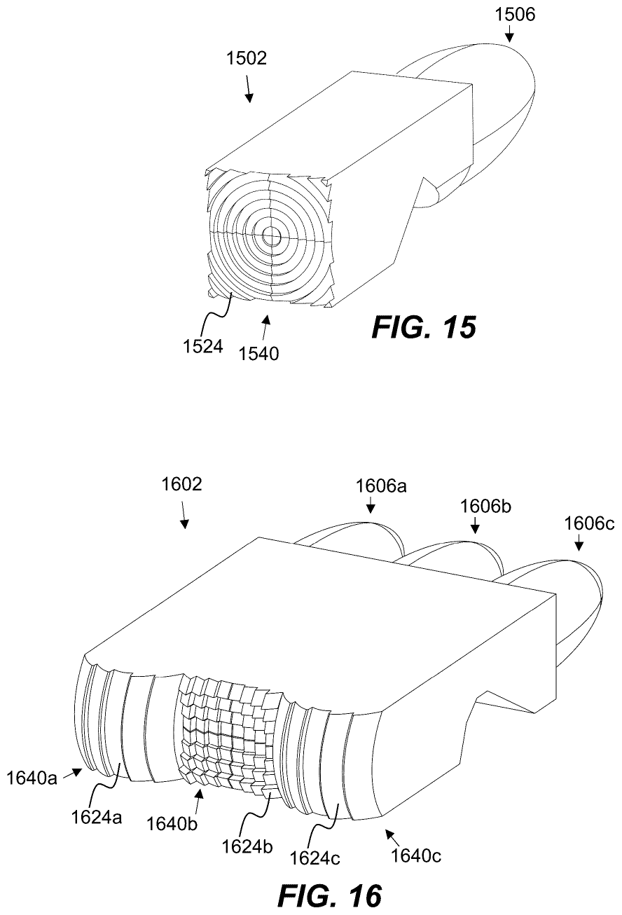

FIG. 15 illustrates an eighth embodiment of the optical element 1502. The optical element comprises an entry portion 1506 and an exit lens 1540. The exit lens comprises a plurality of ring-shaped Fresnel structures 1524. The Fresnel structures take the shape of complete and/or incomplete rings when viewed from ahead, as shown in FIG. 15. The optical element 1502 may otherwise be similar to those shown in FIGS. 3, 13 and 14. Ring-shaped Fresnel structures may be particularly suitable for high beam arrangements due to their optical characteristics.

FIG. 16 illustrates a ninth embodiment of the optical element 1602. The optical element comprises a plurality of entry portions 1606a-c and a plurality of exit lenses 1640a-c, one for each entry portion. The optical element comprises Fresnel structures of two different types: first and third exit lenses 1640a, 1640c comprise horizontally stacked vertical Fresnel structures 1624a, 1624c, and a second exit lens 1640b comprises horizontally and vertically stacked square Fresnel structures 1624b. These Fresnel structures 1624b are similar to those of FIG. 14, albeit of a smaller size and thus of a different type. This allows for precise control of the light pattern. With respect to its other features, the optical element 1602 may be similar to those shown in FIGS. 10 and 11.

In general, Fresnel structures may refer to lens fragments that are translated along the longitudinal direction z of a lens to achieve lens with a reduced thickness. Any Fresnel structures used to form Fresnel lenses are suitable for use as the Fresnel structures in any of the embodiments. In this sense, the exit lenses with Fresnel structures described herein may be considered Fresnel lenses. They achieve similar optical properties relevant for forming the desired light pattern as ordinary lenses, but within a smaller space along the longitudinal direction z. The Fresnel structures may have curved surfaces and/or flat surfaces. These surfaces refer to the light emitting surfaces of the Fresnel structures of the exit lens.

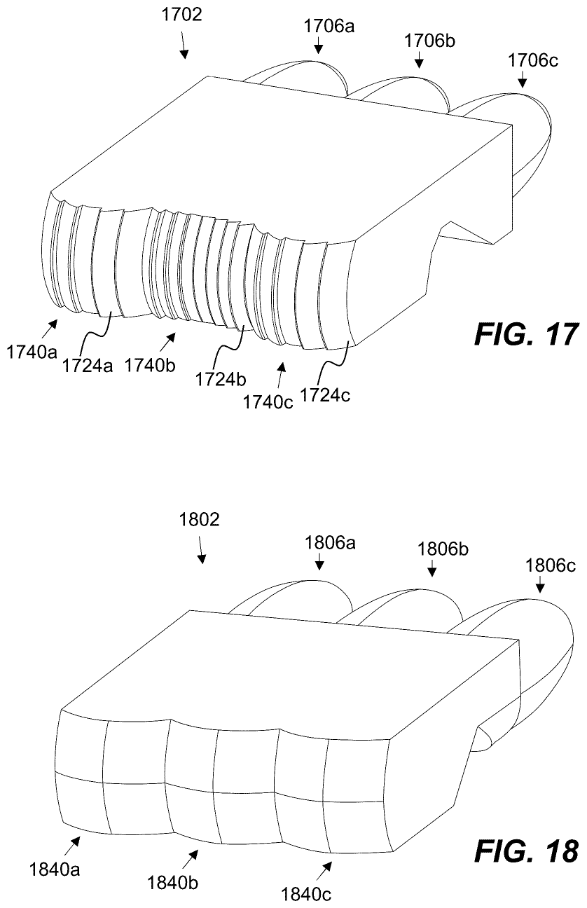

FIG. 17 illustrates a tenth embodiment of the optical element 1702 with Fresnel structures of two different types. The optical element 1702 comprises a plurality of entry portions 1706a-c with corresponding plurality of exit lenses 1740a-c at the exit portion of the optical element. A first exit lens 1740a comprises a first plurality of Fresnel structures 1724a, a second exit lens 1740b comprises a second plurality of Fresnel structures 1724b, and a third exit lens 1740c comprises a third plurality of Fresnel structures 1724c. In this embodiment, the first plurality of Fresnel structures 1724a and the third plurality of Fresnel structures 1724b are of the same type, and the second plurality of Fresnel structures 1724b are of a different type than the first and third pluralities of Fresnel structures. In this case, all Fresnel structures shown are horizontally and vertically stacked vertical Fresnel structures, similarly to those shown in FIG. 13. However, the second plurality of Fresnel structures have a different horizontal pitch or spacing, i.e. the Fresnel structures have a different size in the horizontal direction, and thus are of a different type. More specifically, the second plurality of Fresnel structures are narrower in the horizontal direction than the first and third pluralities of Fresnel structures. This allows for more precise control of the overall light pattern of the optical element as different effects may be assigned to each exit lens, or even within a single exit lens, using different types of Fresnel structures. The optical element 1702 may otherwise be similar to those shown in FIGS. 10, 11 and 16.

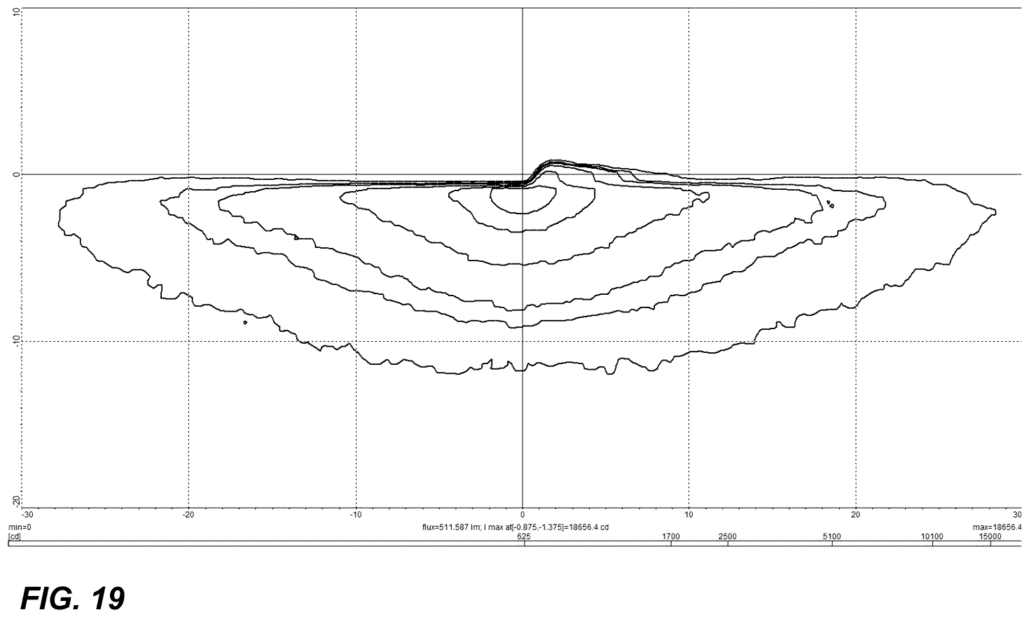

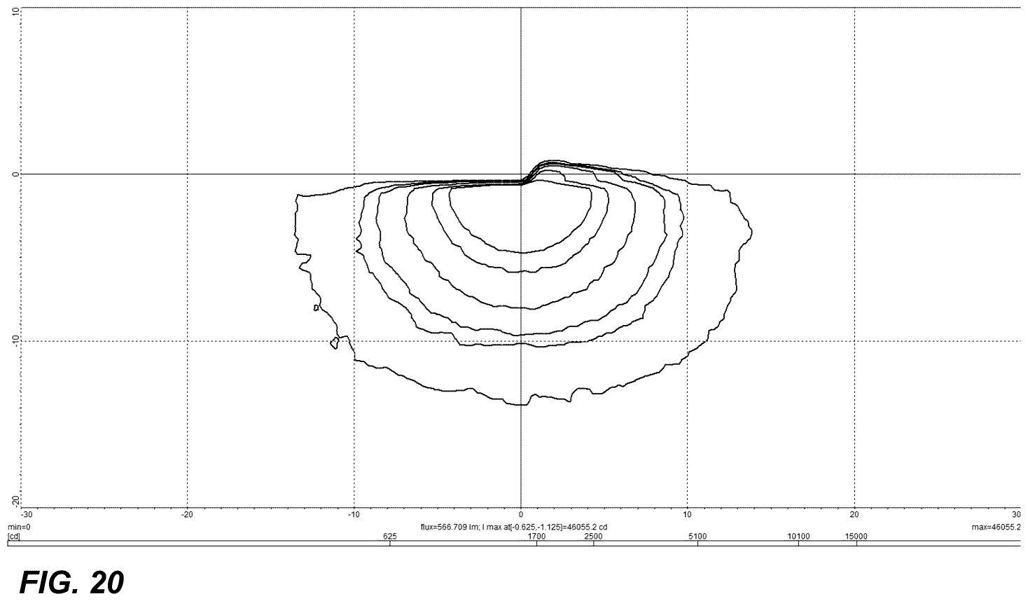

FIG. 18 illustrates an eleventh embodiment of the optical element 1802. The optical element 1802 comprises a plurality of entry portions 1806a-c with corresponding plurality of exit lenses 1840a-c at the exit portion of the optical element. The optical element is otherwise similar to the tenth embodiment, but it lacks the Fresnel structures described above and shown in FIG. 17, i.e. the exit lenses 1840a-c are devoid of Fresnel structures. Effects of the Fresnel structures of the tenth embodiment will now be discussed using simulated light patterns generated for the tenth and eleventh embodiments.

FIG. 19 shows a simulated light pattern for the tenth embodiment, and FIG. 20 shows a simulated light pattern for the eleventh embodiment. Both embodiments are able to produce a light pattern with a cut-off around zero vertical degrees and a bright central beam around zero horizontal degrees, as well as an asymmetric light pattern for right-traffic due to a shape of the light cutter, as discussed in relation to FIG. 10. However, the tenth embodiment with the Fresnel structures may be used to produce a significantly wider light pattern than the eleventh embodiment. The Fresnel structures allow for spreading light rays with higher angles of incidence, when compared to one individual surface. The spreading and/or collimating provided by the Fresnel structures of different types may be used—alone or in combination with exit lens(es) devoid of Fresnel structures—to optimize light patterns.

Even though the embodiments shown in FIGS. 13 to 18 have been illustrated as low beam variants (i.e. with light cutters), they may also be implemented as high beam variants (i.e. without light cutters).

FIG. 21 and FIG. 22 illustrate various configurations of focal points within the optical element. In FIG. 21, an optical axis 2100 extends from a TIR surface (not shown) at the left end of the optical axis to an exit lens (not shown) at the right end of the optical axis. The optical axis extends along the longitudinal direction z of the optical element.

A point 2102 along the optical axis may represent a focal point of the exit lens. Alternative positions 2104, 2106, 2108 for the focal point of the TIR surface are shown along the optical axis. A first alternative focal point 2104 is between the focal point of the exit lens 2102 and the TIR surface, i.e. translated or offset along the optical axis from the focal point of the exit lens towards the TIR surface. A second alternative focal point 2106 is coincident with the focal point of the TIR surface. A third alternative focal point 2108 is between the focal point of the exit lens 2102 and the exit lens, i.e. translated or offset along the optical axis from the focal point of the exit lens towards the exit lens.

Alternatively or additionally, the point 2102 may represent the position of the light cutter or its tip. Similar alternative focal points 2104, 2106, 2108 are applicable in this case as well.

FIG. 21 shows two alternative directions x and y perpendicular to the longitudinal direction z as the above considerations are applicable to light focusing performed by the TIR in both directions. The focal point considerations explained above are applicable also when the TIR surface has a plurality of focal points, e.g. a first, vertical focal point for focusing the light rays in the vertical direction y and a second, horizontal focal point for focusing the light rays in the horizontal direction x. The two focal points may take the same or different positions. For example:
both focal points are coincident with one of alternative focal points 2104 and 2108
one focal point is coincident with alternative focal point 2106 and the other with alternative focal point 2104 or 2108
one focal point is coincident with alternative focal point 2104 and the other with alternative focal point 2108
both focal points are coincident with alternative focal point 2106

In the second and third alternatives outlined above, the first focal point of the TIR surface is in a different position along the optical axis of the TIR surface than the second focal point of the TIR surface.

In a preferred configuration, the vertical focal point is coincident with alternative focal point 2106, and the horizontal focal point is coincident with alternative focal point 2104 or 2108, and wherein the point 2102 is the focal point of the exit lens (and optionally the position of a light cutter). As discussed in relation to FIG. 1, this produces a precise cut-off light pattern when a light cutter is present, and with thermal benefits. The positions of the vertical and horizontal focal points may be swapped while maintaining the thermal benefits.

In another preferred configuration the vertical focal point is coincident with alterative focal point 2104 or 2108, and the horizontal focal point is coincident with the other one of alternative focal points 2104 and 2108. The point 2102, again being the focal point of the exit lens (and optionally the position of a light cutter) is between the two focal points. Again, thermal benefits are achieved due to widening of thermal peaks within the optical element. The positioning of the focal points is particularly useful when the light cutter is present, as neither focal point coincides with the light cutter, saving it from peak thermal loads.

Focal points of the TIR 2104, 2108 that are not coincident with the focal point of the exit lens have an effect of increasing the uniformity and width of the resulting light pattern.

FIG. 22 shows further configurations of focal points within the optical element. As in FIG. 21, the optical axis 2100 extends from a TIR surface (not shown) at the left end of the optical axis to an exit lens (not shown) at the right end of the optical axis. The optical axis extends along the longitudinal direction z of the optical element. The point 2102 along the optical axis may represent a focal point of the exit lens and/or the position of the light cutter or its tip.

FIG. 22 further shows a second optical axis 2200 of the TIR surface. A first focal point (horizontal or vertical) may be along the first optical axis 2100 at one of alternative focal points as discussed in relation to FIG. 21. A second focal point (the other one of the horizontal or vertical focal points) may be along the second optical axis 2200 at one of alternative focal points 2204, 2206, 2208. First alternative focal point 2204 is between point 2102 and the TIR surface but along the second optical axis 2200 (i.e. offset from the optical axis 2100, second alternative focal point 2206 is at the same distance along the longitudinal direction z from the TIR surface as point 2102 and offset from the optical axis 2100, and third alternative focal point is between point 2102 and the exit lens and offset from the optical axis 2100. The second optical axis 2200 is at a non-zero angle with respect to the first optical axis 2100.

Like FIG. 21, FIG. 22 shows two alternative directions x and y perpendicular to the longitudinal direction z. When the vertical direction y is considered, the focal point considered is preferably the horizontal focal point for focusing light rays in the horizontal direction x. When the horizontal direction x is considered, the focal point considered is preferably the vertical focal point for focusing light rays in the vertical direction y. Both the horizontal and the vertical focal points of the TIR surface may be offset from the optical axis 2100 an be on the same or different alternative optical axes 2200.

Alternative focal point 2208 is offset (forward) towards the exit lens and along the second optical axis. Especially when the horizontal direction x is considered as the axis shown in the figure, this alternative focal point provides for a more uniform light pattern, especially when two headlights with such optical elements are used in combination.

The focal point configurations applied to each TIR surface and exit lens and/or light cutter of the optical element may be the same or have differences with respect to one or more of the other configurations of the optical element. The different configurations are compatible with all of the embodiments disclosed herein. Positioning of the focal points may be implemented with shaping of the TIR surface and the relative distances between the TIR surface and the light cutter and/or the exit lens.

FIG. 23 shows a side view of a twelfth embodiment of the optical element 2302. The optical element comprises an entry portion 2306 and a TIR surface 2308, a light cutter 2304, and an exit portion 2380 with an exit lens 2340 with a plurality of Fresnel structures 2324. The TIR surface 2308 comprises a plurality of facets 2360. The facets deviate from the curvature of a TIR surface without facets and may be flat or preferably curved. Curved facets may be convex (as shown in FIG. 23) and/or concave when viewed from the outside of the optical element. The entire TIR surface may be faceted, or the facets may cover one or more parts of it, leaving one or more further parts of the TIR surface devoid of facets. The facets may be used to shift the focal point(s) of the TIR surface (with respect to an unfaceted TIR surface), and the shape and curvature of the facets may be used to fine-tune the position of the focal point(s). By shifting the focal point(s) closer to the TIR surface, a shorter and thus more compact optical element may be made. The shifting may also be used to position the focal points such that they coincide (or not) with the light cutter 2304 and/or the focal point of the exit lens 2340; the technical effects of these options have been discussed above. Each facet contributes to the light pattern of the optical element and very precise control of the light pattern may be achieved with such facets. Otherwise the optical element 2302 may have the same features as the optical elements shown in FIG. 3, 4, 5, or the other embodiments discussed herein.

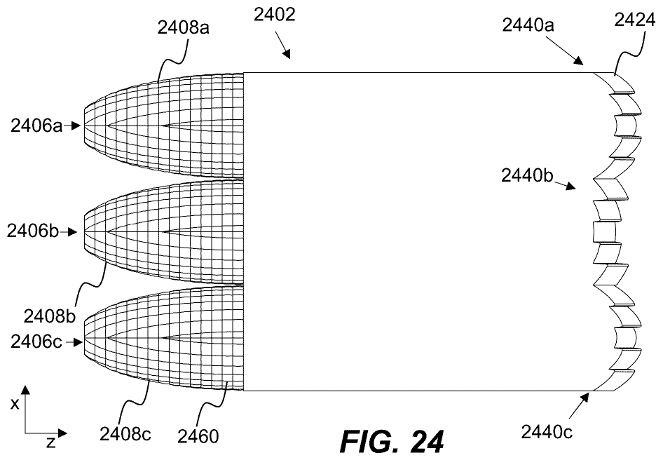

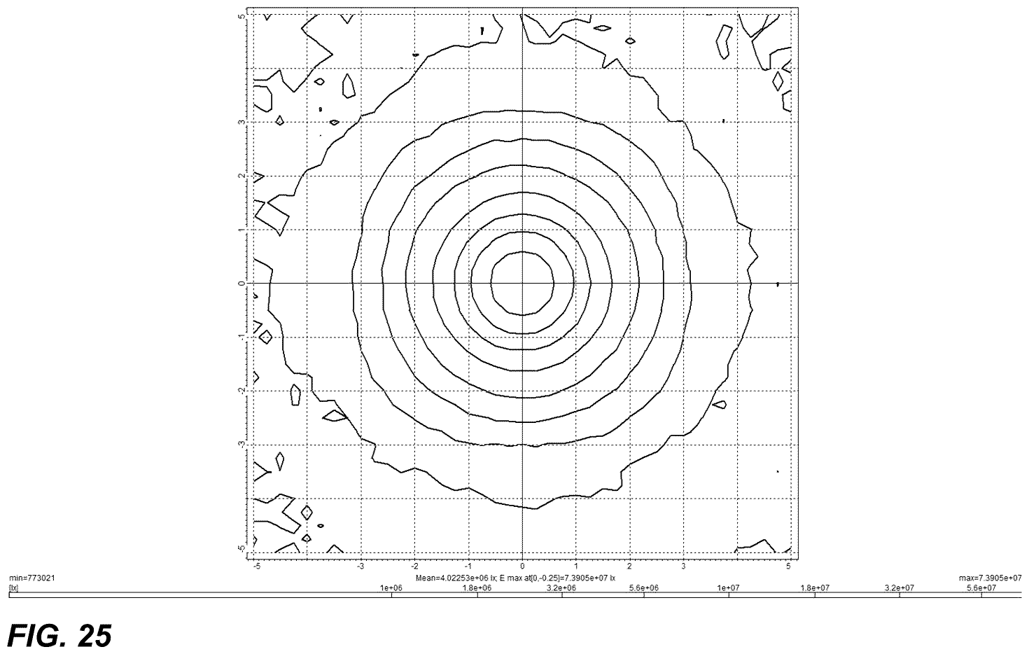

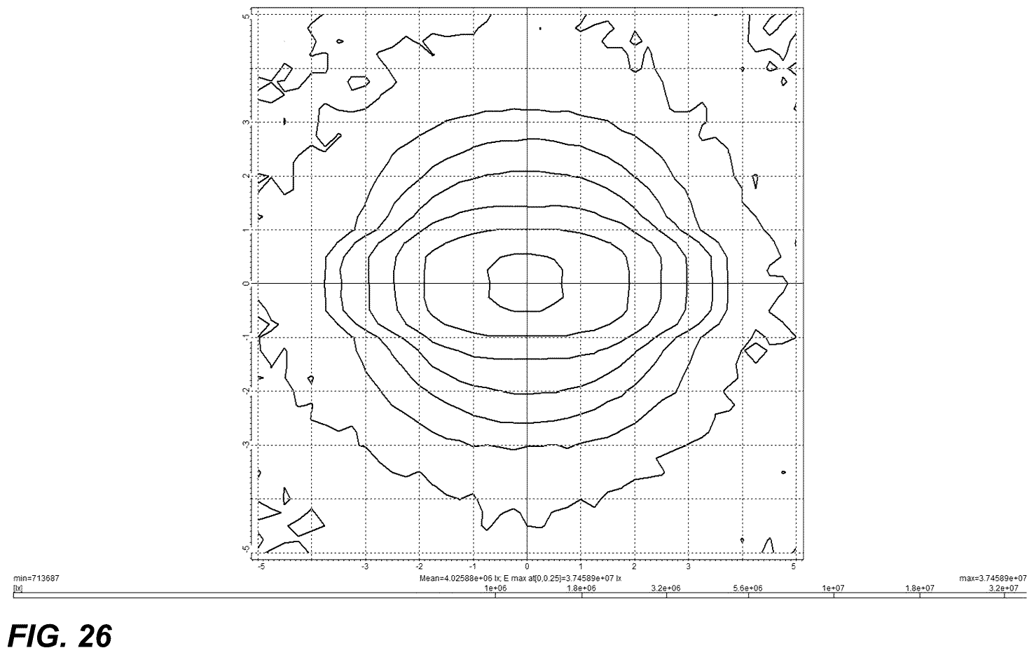

FIG. 24 shows a top view thirteenth embodiment of the optical element 2402. Similarly to the embodiments shown in FIGS. 10 to 12, the optical element 2402 comprises a plurality of entry portions 2406a-c with corresponding plurality of TIR surfaces 2408a-c. The optical element 2402 further comprises an exit portion with a plurality of exit lenses 2440a-c with Fresnel structures 2424. Similarly to the twelfth embodiment, the plurality of TIR surfaces 2408a-c comprise a plurality of facets 2460. Alternatively, one or more of the TIR surfaces may comprise a plurality of the facets, and one or more of the TIR surfaces may be devoid of facets. The details and benefits of the facets have been described above in relation to the twelfth embodiment. Otherwise the optical element 2402 may have the same features as the optical elements shown in FIGS. 10 to 12. The view of FIG. 23 may be considered a side view of the embodiment of FIG. 24.

The effects of the facets are shown in FIGS. 25 and 26, which illustrate simulated light patterns generated by two TIR surfaces which have the same rotational elliptical shape. The TIR surface used to generate the light pattern of FIG. 25 has no facets, and the TIR surface used to generate the light pattern of FIG. 26 is entirely faceted. Both of these TIR surfaces are suitable for use in any of the embodiments described herein. As seen in FIGS. 25 and 26, the facets may be used to widen horizontal spread in the optical element and thus to achieve a wider main beam. Further, thermal benefits as discussed earlier with respect to the positions of the focal point of the TIR surface and a light cutter may be achieved.

FIG. 27 shows a side view of a fourteenth embodiment of the optical element 2702. The optical element 2702 is similar to the other embodiments, such as those shown in FIGS. 3 to 5, 13 to 15, and 23 in that it comprises an entry portion 2706, a TIR surface 2708, a light cutter 2704, and an exit portion 2780 comprising an exit lens 2740 with a plurality of Fresnel structures 2724a, 2724b. Additionally, the optical element comprises a light collector surface 2770 for receiving rays from the light cutter 2704. As discussed in relation to FIG. 1, the light cutter comprises a TIR surface 2710 that reflects light arriving from the TIR surface 2708 and/or directly from the entry portion 2706. The light collector surface then reflects the light rays towards the exit lens 2740 by TIR. These light rays might have been otherwise lost from the light pattern, and their preservation thus increases efficiency of the optical element. Here, the light collector surface 2770 is configured to collimate the light rays received from the light cutter in the vertical direction y such that they become perpendicular to the vertical direction y.

The exit lens 2740 comprises first Fresnel structures 2724a configured to tilt first light rays exiting the optical element. The first light rays are mainly those reflected by the light collector surface 2770. The exit lens comprises second Fresnel structures 2724b configured to collimate second light rays exiting the optical element. The second light rays are mainly those arriving directly from the entry portion 2706 or from the TIR surface 2708. An alternative optical element with a reduced height (in the vertical direction y) has a flat top such that the optical element only extends up to the path(s) of the topmost light ray(s) 2700 reflected by the light collector surface 2770 towards the exit lens 2740. The flat top may extend along the topmost light ray 2700 drawn in FIG. 27. This optical element is otherwise similar in appearance and performance to the optical element 2702 shown in FIG. 27, but with the part above topmost light ray 2700 cut out to achieve a more compact design without noticeably affecting the resulting light pattern.

FIG. 28 illustrates a fifteenth embodiment of the optical element 2802. The optical element is similar to the fifth embodiment of FIGS. 10 and 11 and comprises a plurality of entry portions 2806a-c with corresponding plurality of TIR surfaces 2808a-c. The optical element 2802 further comprises an exit portion 2880 with a plurality of exit lenses 2840a-c with corresponding Fresnel structures 2824a-c. The optical element comprises a light cutter 2804 comprising a TIR surface 2810 that reflects light arriving from the TIR surfaces 2808a-c and/or directly from the entry portions 2706a-c.

Similarly to the embodiment of FIG. 27, the optical element 2802 further comprises light collector surfaces 2870a-c, one for each of the entry portions and/or TIR surfaces, for receiving rays from the light cutter 2804. Light rays travel in within the embodiment of FIG. 28 as shown in FIG. 27; the view of FIG. 27 may be considered a side view of the embodiment of FIG. 28. The light rays exit the optical element 2802 via exit lenses 2840a-c and their Fresnel structures 2824a-c. As mentioned in relation to FIG. 27, an alternative optical element with a flat top (i.e. with the parts above topmost light ray(s) reflected by the light collector surfaces 2870a-c towards the exit lenses 2840a-c cut out) may be implemented for a more compact design without noticeably affecting the resulting light pattern.

Different properties described herein for the TIR surface(s), such as the facets and/or positions of focal points, may also be applied to the light collector surface(s) in addition to or alternatively to the TIR surfaces. This provides similar benefits as when these properties are applied to the TIR surface(s).

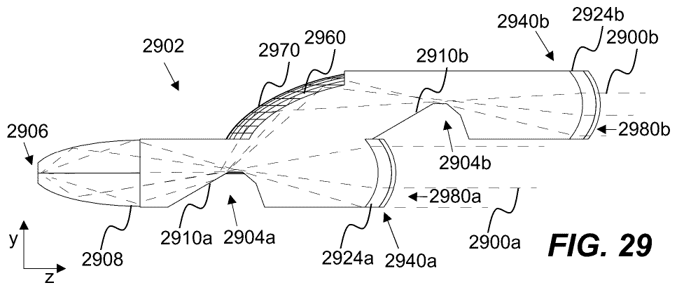

FIG. 29 illustrates a sixteenth embodiment of the optical element 2902. The optical element comprises an entry portion 2906 and a corresponding TIR surface 2908. The optical element comprises a plurality of light cutters 2904a-b and a plurality of exit portions 2980a-b. A first light cutter 2904a receives light rays directly from the entry portion 2906 and/or from the TIR surface 2908. First light rays 2900a that pass the first light cutter exit the optical element via the first exit portion 2980a, more specifically its first exit lens 2940a with first Fresnel elements 2924a. Second light rays 2900b reflected by a TIR surface 2910a of the first light cutter 2904a travel to a light collector surface 2970 of the optical element. Similarly to the light collector surfaces of FIGS. 27 and 28, the light collector surface 2970 reflects the light rays 2900b towards a second exit portion 2980b of the optical element. These second light rays 2900b exit the optical element via a second exit lens 2940b of the second exit portions. The second exit lens has Fresnel structures 2924b, however, either Fresnel structures 2924a or 2924b may be left out.

The optical element 2902 further comprises a second light cutter 2904b for forming a cutoff profile for the second light rays 2900b. However, this light cutter is optional and may be left out if its cutoff profile is not desired in the resulting light pattern.

The optical element 2902 further comprises facets 2960 in the light collector surface 2970. As mentioned above, these facets may be similar to those of the TIR surface(s) discussed in relation to the embodiments of FIGS. 23 and 24. Alternatively, facets may be provided in the TIR surface 2908, or in both the TIR surface 2908 and the light collector surface 2970.

The optical element of FIG. 29 may be implemented with a single entry portion as show in various other embodiments, and may otherwise have the characteristics of any of these embodiments. Alternatively, the optical element of FIG. 29 may be implemented with a plurality of entry portions such as in the embodiments of FIG. 6-12, 16-18, 24 or 28. The optical element may otherwise have the characteristics of any of these embodiments.

Further exit portions may be added to the optical element of FIG. 29 in a cascade such that each exit portion receives light rays via a light collector surface and a light cutter in the manner shown in FIG. 29. Each exit portion, light collector surface and light cutter add to the efficiency of the optical element as light reflected away from a preceding exit portion by a preceding light cutter is redirected in the direction of another exit portion by a corresponding light collector surface. A bright central beam is a benefit of all variants of the embodiment.

Example simulations have shown an efficiency of 75-80% with the solution of FIG. 29 alone. This may be compared to an efficiency of 45% for an equivalent optical element without light collector surfaces or additional exit portions. Both solutions may achieve the same cutoff light pattern.

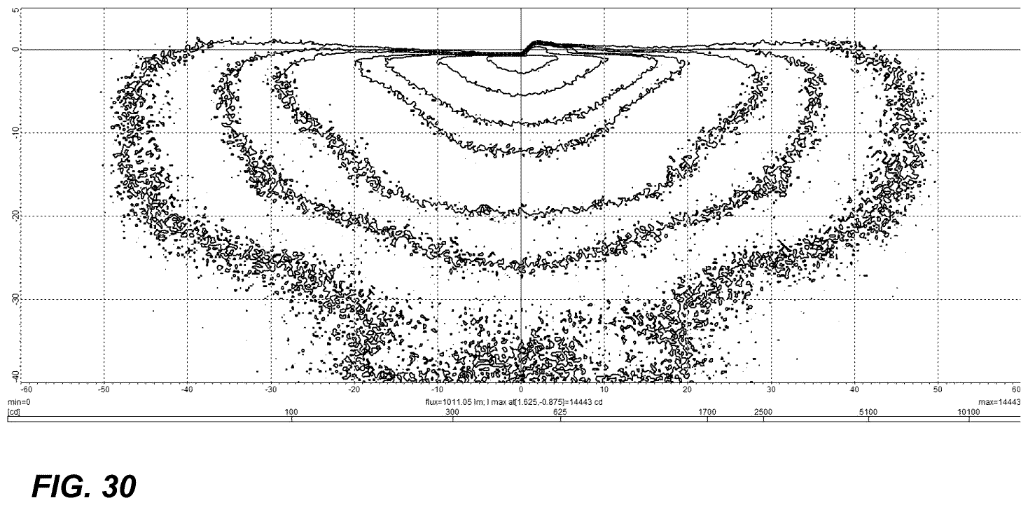

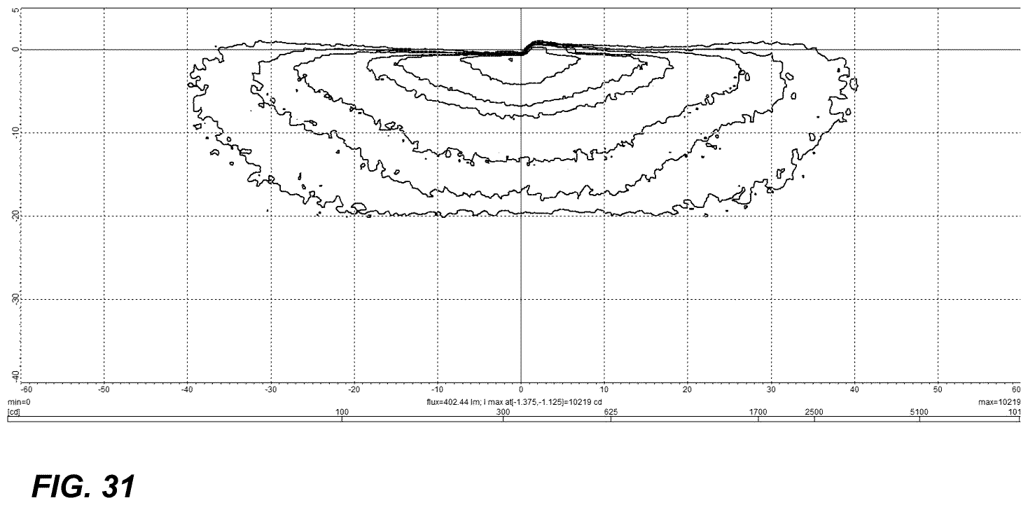

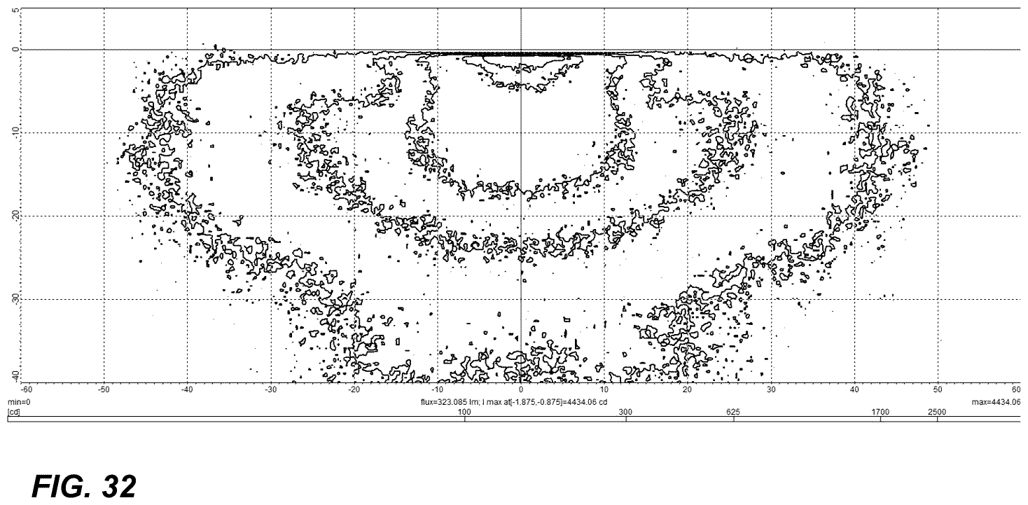

FIG. 30 shows a simulated light pattern for a total beam of the sixteenth embodiment. The light pattern demonstrates a cut-off around zero vertical degrees and slight asymmetry for right-traffic due to an optional shape of the light cutter, an example of which is provided in relation to FIG. 10. The light pattern is formed as the sum of upper and lower beams; the lower beam is formed by first light rays 2900a exiting the optical element 2902 via the first exit portion 2980a, and the upper beam is formed by second light rays 2900b exiting the optical element 2902 via the second exit portion 2980b (see FIG. 29). FIG. 31 shows a simulated light pattern for the lower beam, and FIG. 32 shows a simulated light pattern for the upper beam of the sixteenth embodiment. The figures show that the upper beam noticeably contributes to the overall light pattern, both its size and shape. The light collector surface is thus able to recover light rays that might otherwise be lost, and the recovered light rays are further targeted by the exit lens through which these light rays exit the optical element. A separate exit portion for these light rays allows for flexibility in controlling the light rays e.g. with light cutters, as illustrated in FIG. 29.

FIG. 33 illustrates a vehicle headlamp 3300 with an optical element according to a seventeenth embodiment. The headlamp 3300 may be implemented as a low beam headlamp with a suitable light cutter in the optical element, or as a high beam headlamp without such a light cutter in the optical element. FIG. 34 shows a front view of the headlamp 3300. The headlamp shown comprises a housing 3400. It is suitable for attaching to a vehicle, such as a working vehicle, using e.g. fixtures 3390a-c and/or 3392a-d.

The headlamp 3300 comprises a plurality of LED light sources, one for each of three entry portions of the optical element (not shown). Features of the optical element hidden from view in FIGS. 33 and 34 may be implemented as in any of the embodiments of FIGS. 6 to 12, 16 to 18, 24 and 28, for example. The optical element according to the seventeenth embodiment comprises a plurality of horizontally adjacent exit lenses 3340a-c. Two exit lenses 3340a, 3340c comprise respective Fresnel structures 3324a, 3324c. The middle exit lens 3340b is devoid of Fresnel structures. The configuration of exit lenses of the embodiment, and more specifically the Fresnel structures of the exit lenses on both sides of the lens without Fresnel structures, allow for reducing scattered or stray light. As an alternative example, horizontally and/or vertically adjacent exit lenses with or without Fresnel structures may be implemented in some or all of the four quadrants of the middle exit lens 3340b shown in the figures to provide further control of the light pattern.

Any other optical element is also suitable for use in the headlamp 3300. For example, the optical elements of FIGS. 6 to 12, 16 to 18, 24 and 28 may be used. Alternatively, a plurality of optical elements may be used in the headlamp 3300. For example, three optical elements may be stacked horizontally such that a first optical element provides exit lens 3340a, a second optical element without Fresnel structures provides exit lens 3340b, and a third optical element provides 3340c as shown in the figures. Suitable optical elements include those shown in FIGS. 1 to 5, 13 to 15, 23 and 27, for example.

The headlamp 3300 of FIGS. 33 and 34 has a compact structure. For example, the optical element (and thus other optical elements described herein) may be 10 millimeters (mm) tall in the vertical direction y and 30 mm wide in the horizontal direction x. The headlamp 3300 may be 60 mm wide in the horizontal direction x, and 25 mm tall in the vertical direction y when the flanges for the fixtures 3390a-d are excluded from the measurement.

When implemented as a low beam headlamp, the headlamp 3300 shown in FIGS. 33 and 34 may achieve a simulated optical efficacy of 44% with an optical element made of PMMA, or a simulated optical efficiency of 28% with an optical element made of PC.

While several embodiments of the optical element with one or three entry portions have been illustrated and described, the optical element may have any number of entry portions. Other parts of the optical element (such as TIR surfaces) and of the headlamp (such as light sources) may be present in corresponding numbers.

All of the following configurations are contemplated for the Fresnel structures, which may be configured to perform the following on light rays:
collimate only in the horizontal direction x;
collimate only in the vertical direction y;
collimate in both the horizontal direction x and in the vertical direction y;
spread only in the horizontal direction x;
spread only in the vertical direction y;
spread in both the horizontal direction x and in the vertical direction y;
spread in the vertical direction y and collimate in the horizontal direction x; or
collimate in the vertical direction y and spread in the horizontal direction x.

If desired, the different functions discussed herein may be performed in a different order and/or concurrently with other. Furthermore, if desired, one or more of the above-described functions and embodiments may be optional or may be combined.

Although various aspects of the embodiments are set out in the independent claims, other aspects comprise other combinations of features from the described embodiments and/or the dependent claims with the features of the independent claims, and not solely the combinations explicitly set out in the claims.

It is also noted herein that while the above describes example embodiments, these descriptions should not be viewed in a limiting sense. Rather, there are several variations and modifications, which may be made without departing from the scope of the present disclosure as defined in the appended claims.

The invention claimed is:

1. An optical element for a vehicle headlamp, wherein the optical element comprises:
one or more entry portions for receiving light rays from one or more light sources;
one or more total internal reflection (TIR) surfaces configured to receive light rays from the one or more entry portions and to focus, by TIR, the light rays received from the one or more entry portions in a vertical direction (y) and in a horizontal direction (x); and
one or more exit portions comprising one or more exit lenses, wherein the one or more exit lenses comprise a plurality of Fresnel structures configured to collimate and/or spread, in the horizontal direction and/or in the vertical direction, light rays exiting the optical element,
wherein the optical element is formed as a monolithic body.

2. The optical element of claim 1, wherein the optical element comprises one or more light cutters configured to form, by TIR, a cutoff profile for light rays passing from the one or more entry portions to the one or more exit lenses.

3. The optical element of claim 2, wherein the optical element comprises one or more light collector surfaces configured to receive light rays reflected by the one or more light cutters, and to reflect, by TIR, the light rays received from the one or more light cutters towards the one or more exit lenses, and optionally wherein:
at least one of the one or more light collector surfaces is configured to collimate the light rays received from the one or more light cutters towards the one or more exit lenses, and/or
at least one of the one or more light collector surfaces is configured to focus the light rays received from the one or more light cutters in the vertical direction and in the horizontal direction.

4. The optical element of claim 3, wherein the optical element comprises a plurality of light cutters and a plurality of exit portions, and
wherein first one or more light cutters of the plurality of light cutters are arranged to form a cutoff profile for light rays received from the one or more entry portions and/or from the one or more TIR surfaces and configured to exit the optical element via first one or more exit portions of the plurality of exit portions, and
wherein second one or more light cutters of the plurality of light cutters are arranged to form a cutoff profile for light rays received from the one or more light collector surfaces and configured to exit the optical element via second one or more exit portions of the plurality of exit portions.

5. The optical element of claim 3, wherein the one or more TIR surfaces and/or the one or more light collector surfaces comprise a plurality of flat and/or curved facets.

6. The optical element of claim 1, wherein the plurality of Fresnel structures comprise:
ring-shaped Fresnel structures, and/or
horizontally and/or vertically stacked rectangular Fresnel structures.

7. The optical element of claim 1, wherein the one or more exit portions comprise one or more exit lenses devoid of Fresnel structures.

8. The optical element of claim 1, wherein the plurality of Fresnel structures comprise Fresnel structures of at least two different types.

9. The optical element of claim 1, wherein at least one TIR surface of the one or more TIR surfaces has a first focal point and a second focal point for focusing the light rays received from the one or more entry portions, wherein the first focal point and the second focal point are substantially coincident, or
wherein the first focal point and the second focal point are noncoincident, and optionally wherein one of the first focal point and the second focal point is positioned further from the at least one TIR surface than the other one of the first focal point and the second focal point and/or the first focal point and the second focal point are in different positions in the horizontal direction.

10. The optical element of claim 1, wherein the one or more exit lenses comprise a plurality of exit lenses comprising a plurality of the Fresnel structures.

11. The optical element of claim 1, wherein the optical element comprises a plurality of entry portions for receiving light rays from the one or more light sources, and a plurality of TIR surfaces configured to receive light rays from the plurality of entry portions and to focus, by TIR, the light rays received from the plurality of entry portions in the vertical direction (y) and in the horizontal direction (x).

12. The optical element of claim 11, wherein the plurality of TIR surfaces comprise substantially parallel optical axes for focusing the light rays.

13. The optical element of claim 11, wherein the plurality of TIR surfaces comprise substantially nonparallel optical axes for focusing the light rays.

14. The optical element of claim 11, wherein the one or more exit lenses comprise a plurality of exit lenses, wherein:
the plurality of exit lenses include at least one exit lens for each of the plurality of TIR surfaces, and/or a plurality of horizontally and/or vertically adjacent exit lenses.

15. The optical element of claim 1, wherein at least one of the one or more exit portions comprises only one of the one or more exit lenses.

16. The optical element of claim 1, wherein the plurality of Fresnel structures of at least one of the one or more exit lenses comprise first Fresnel structures configured to collimate light rays exiting the optical element and second Fresnel structures configured to spread light rays exiting the optical element.

17. The optical element of claim 1, wherein the plurality of Fresnel structures of at least one of the one or more exit lenses are configured to spread light rays exiting the optical element at two or more different spread angles.

18. A lighting unit comprising:
one or more light sources; and
one or more optical elements, wherein an optical element comprises:
one or more entry portions for receiving light rays from the one or more light sources;
one or more TIR surfaces configured to receive light rays from the one or more entry portions and to focus, by TIR, the light rays received from the one or more entry portions in a vertical direction (y) and in a horizontal direction (x); and
one or more exit portions comprising one or more exit lenses,
wherein the one or more exit lenses comprise a plurality of Fresnel structures configured to collimate and/or spread, in the horizontal direction and/or in the vertical direction, light rays exiting the optical element,
wherein the optical element is formed as a monolithic body.

19. A vehicle comprising:
a lighting unit, the lighting unit comprising:
one or more light sources; and
one or more optical elements, each optical element comprising:
one or more entry portions for receiving light rays from the one or more light sources;
one or more TIR surfaces configured to receive light rays from the one or more entry portions and to focus, by TIR, the light rays received from the one or more entry portions in a vertical direction (y) and in a horizontal direction (x); and
one or more exit portions comprising one or more exit lenses,
wherein the one or more exit lenses comprise a plurality of Fresnel structures configured to collimate and/or spread,
in the horizontal direction and/or in the vertical direction,
light rays exiting the optical element,
wherein the optical element is formed as a monolithic body.
